(19) United States
(12) Patent Application Publication
(10) Pub. No.: US 2011/0068137 A1
(43) Pub. Date: Mar. 24, 2011

(54) ADJUSTABLE KAYAK CARRIER

(76) Inventors: Frederick G. Murray, Southington, CT (US); William E. Fortune, Branford, CT (US)

(21) Appl. No.: 12/887,957

(22) Filed: Sep. 22, 2010

Related U.S. Application Data
(60) Provisional application No. 61/244,741, filed on Sep. 22, 2009.

(51) Int. Cl. B60R 9/00; B60R 9/04

(52) U.S. Cl. 224/318; 224/309

(57) ABSTRACT

A kayak carrier for a vehicle that can be adjusted infinitely for supporting a wide range of kayaks of various sizes is disclosed herein. The kayak carrier can include four supports, two for the front and two for the rear of a vehicle. The supports can be comprised of foam and have through holes to accept a guide to couple the supports together, thereby forming saddles which can rest on the rear and the front of a vehicle. The kayak carrier can be secured to the vehicle via straps. A kayak can be secured to the kayak carrier via straps or netting. The rear supports can further include a relatively low-friction surface, compared to the front supports, to facilitate sliding to ease kayak installation. The front supports can include a relatively high-friction surface, compared to the rear supports, to prevent slippage. Additionally, the bottom surfaces of the supports can include a similar relatively high-friction surface to prevent the supports from sliding on the roof of the vehicle.

### CROSS-REFERENCE TO RELATED APPLICATIONS

This is application claims priority to provisional Application No. 61/244,741, the disclosure of which is hereby incorporated by reference in its entirety.

### FIELD

The present disclosure refers to an adjustable support. More specifically, the disclosure refers to a support for a kayak on a vehicle roof

### BACKGROUND

Kayaking enthusiasts often need to transport their watercraft long distances to reach the rivers and lakes that they desire to paddle. Accordingly, they need a method to transport their kayak safely. These enthusiasts often use their vehicles to transport their watercraft.

A disadvantage of kayak carriers in the prior art is the difficulty that consumers face when purchasing a kayak carrier for their kayak. Consumers may have difficulty in finding a kayak carrier that is compatible with their particular kayak. Moreover, when a consumer does find a suitable kayak carrier, it is likely not designed for their specific kayak, and therefore provides an imperfect fit. Accordingly, the kayak may not fit well in the carrier because the carrier may be configured to support a specific kayak.

Other kayak carriers found in the prior art also require purchasing additional equipment such as a multi-purpose rack that is compatible with the carrier. Multi-purpose racks cause additional cost and time for installation.

Accordingly, there is a need to have a cost-effective kayak carrier compatible with many different size kayaks.

### BRIEF DESCRIPTION OF THE FIGURES

An adjustable kayak carrier according to the present disclosure shall hereafter be described with reference to the enclosed figures, in which:

FIG. 1 is an illustration of one block in accordance with the present disclosure;

FIG. 2 is an illustration of an exemplary kayak saddle in a first configuration in accordance with the present disclosure;

FIG. 3 is an illustration of the exemplary kayak saddle in a second configuration using a guide;

FIG. 4 is an illustration of two saddles forming a kayak carrier in accordance with the present disclosure;

FIG. 4A is an illustration of two saddles forming a kayak carrier in accordance with the present disclosure;

FIG. 5 is an illustration of the exemplary carrier of FIG. 4 on a vehicle;

FIG. 6 is an illustration of the exemplary carrier of FIG. 4 with a kayak installed on the carrier; and

FIG. 7 is an illustration of a block with a relatively low or high-friction surface on top of the block.

### SUMMARY

Embodiments of the present disclosure include an adjustable kayak carrier for a vehicle roof comprising a first saddle for a rear of a kayak and a second saddle for a front of the kayak. Each saddle comprises two adjustable supports, which move relative to one another, perhaps on a guide, to conform to an infinite number of kayak sizes within the bounds of the vehicle.

Embodiments of the present disclosure deliver a kayak carrier that provides a suitable fit for any size kayak, thereby preventing confusion when purchasing a kayak carrier. The term “kayak” is defined as any elongated watercraft that is capable of supporting at least one person on a waterway and that may or may not have a mechanized transport structure.

Further embodiments of the present disclosure provide a kayak carrier that does not require, but could be used with, a multi-purpose vehicle rack. Providing a carrier that does not need an additional multi-purpose rack reduces cost and installation time by simplifying the carrier. Specifically, the kayak carrier may rest directly on, and in contact with, the roof of a vehicle. However, some embodiments of the present disclosure can be compatible with a multi-purpose rack so that multi-purpose rack owners can benefit from the features disclosed herein.

Embodiments of the present disclosure also prevent the pads and kayak from slipping relative to one another and relative to the vehicle roof. Movement on the vehicle roof can be prevented by using a surface with a high coefficient of friction on the base of the pad to prevent the pad from sliding on the vehicle roof. As is known, the coefficient of friction is defined as force of friction between two bodies and the force pressing them together. A similar high-friction surface can be applied to one of the kayak saddles to prevent the kayak from slipping. Moreover, a surface with a relatively low coefficient of friction can be applied to the other of the saddles to ease installation of a kayak on the saddles.

Embodiments of the present disclosure include first and second supports including a top surface having a slope relative to corresponding bottom surfaces in which the slopes of the first and second supports form a generally concave receiving surface in an installed configuration for a front of a vehicle. These embodiments also disclose third and fourth supports, which can include a top surface having a slope relative to corresponding bottom surfaces in which the slopes of the third and fourth supports form a generally concave receiving surface in an installed configuration for a rear of a vehicle. In one arrangement, the first and second supports can be arranged to support a first end of a kayak, and the third and fourth supports can be arranged to support a second end of the kayak.

The supports can rest on the vehicle in an installed configuration. Each of the supports can further have a through-hole extending length-wise from one end to another. The carrier can include a first guide that can be configured to slidably engage the first and second supports. The carrier can also include a second guide configured to slidably engage the third and fourth supports. Some embodiments include a first strap configured to secure the first and second supports to the front of the vehicle and a second strap configured to secure the third and fourth supports to the rear of the vehicle. As an example, the first and second supports can further include a relatively high-friction surface compared to surfaces of the third and fourth supports, thereby resisting movement of a kayak in an installed configuration. Similarly, the third and fourth supports can include a relatively low-friction surface compared to surfaces of the first and second supports, thereby facilitating a sliding motion during installation of a kayak. As another example, the first and second guides can be composed of a substantially rigid material or foam. Netting can be used for securing a kayak to the kayak carrier. Moreover, the through-holes can be configured for being coupled to a multi-purpose vehicle roof rack. In one particular arrangement, the supports can have a generally trapezoidal block-like shape.

Other embodiments of the present disclosure include first, second, third and fourth supports, each having at least one through-hole and first and second guides, in which the through-holes of the first and second supports can be configured to slidably accept the first guide to form a first saddle. In addition, the through-holes of the third and fourth supports can be configured to slidably accept the second guide to form a second saddle. The first and second guides can each include two ends and a channel with openings on each end of each of the guides. The embodiments can further include first and second fasteners corresponding to the channels of the first and second guides respectively, in which the fasteners, for example straps, are configured to couple the first and second guides to a vehicle. The first and second supports can include a relatively high-friction surface compared to surfaces of the third and fourth supports, thereby resisting movement of a kayak in an installed configuration. The third and fourth supports can include a relatively low-friction surface compared to surfaces of the first and second supports, thereby facilitating a sliding motion during installation of a kayak. The guides can be formed using a substantially rigid material. The first and second guides can constitute portions of a multi-purpose vehicle roof rack.

An additional embodiment of the present disclosure includes a first saddle and a second saddle, in which the first and second saddles each include two blocks with one or more longitudinal through-holes. The first and second saddles further include at least one guide, comprising two ends, extending through at least one of the longitudinal through-holes, in which each guide has an opening extending from one end of the guide to the other end. One or more straps can fit through the opening of each of the at least one guide and configured to attach the kayak carrier to a vehicle.

### DESCRIPTION OF EXEMPLARY EMBODIMENTS

Embodiments will be described more fully hereinafter with reference to the accompanying drawings. Other embodiments are contemplated in many different forms and this disclosure should not be construed as limited to the embodiments set forth herein; rather, these embodiments are provided so that this disclosure will be thorough and complete, and will fully convey the scope of the disclosure to those skilled in the art. In the drawings, like numbers refer to like elements.

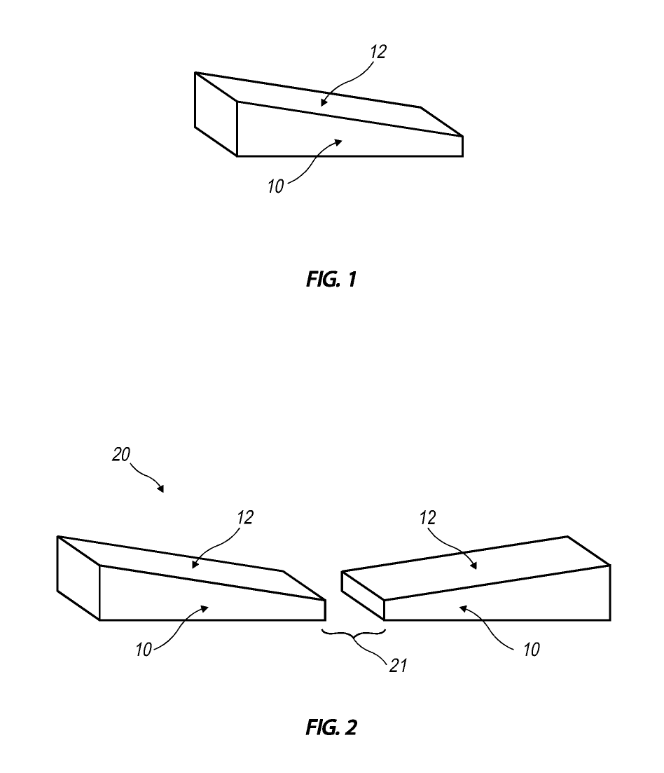

FIG. 1 illustrates a support 10 in accordance with the present disclosure. Support 10 comprises a block-like shape with top surface 12. Top surface 12 can be flat, but can be sloped relative to corresponding bottom surfaces (not illustrated), thereby forming a trapezoidal block-like shape. Block 10 can be composed of solid foam, a viscoelastic material, or some other non-abrasive material to avoid scratching a vehicle roof. A “support” is defined as any structure that can be positioned on the roof or other surface of a vehicle and that can present one or more surfaces for engaging a component to be carried by the vehicle.

FIG. 2 is an illustration of kayak saddle 20 in a configuration in which supports 10 can be separated from each other by gap 21. The supports 10 can be further arranged such that their slopes 12 are facing inward to form a valley or generally concave surface to receive a kayak. Gap 21 can be adjusted to conform to the dimensions of most kayak hulls. The size of gap 21 can be infinitely adjustable within the bounds of the vehicle. Accordingly, kayak saddle 20 can be reused if a new kayak is purchased that has a different hull shape compared to a previously transported kayak.

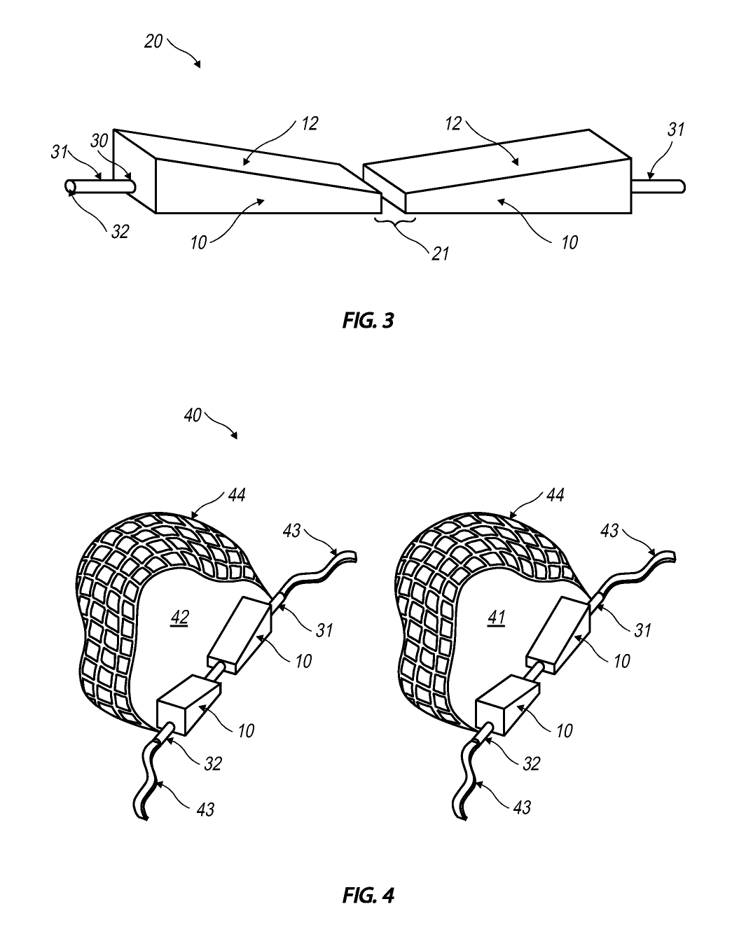

In FIG. 3, supports 10 can further comprise through-holes 30, which can receive guide 31. However, in other embodiments, fasteners such as straps can be used instead of guide 31. Through-holes 30 can extend length-wise from one end of supports 10 to another. In the illustrated embodiment, guide 31 is depicted extending through through-holes 30. Guide 31 can be any elongate shape; for example, it can be cylindrically shaped. Accordingly, guide 31 is configured to slidably engage supports 10 and through-holes 30. Guide 31 further comprises channel 32 for receiving a strap and/or netting (not shown) that can be used to secure kayak saddle 20 to a vehicle. Channel 32 proceeds continuously from one end of guide 31 to the other and comprises openings at both ends. Guide 31 may also be manufactured using a substantially rigid material such as plastic. However, in other embodiments guide 31 can be manufactured from a more flexible material to allow it to conform to a roof having a non-planar surface.

In another configuration, gap 21 can be closed such that supports 10 are joined together. When gap 21 is closed, this is the minimum size of kayak saddle 20. Typically, kayak hulls will not be smaller than the minimum size of kayak saddle 20.

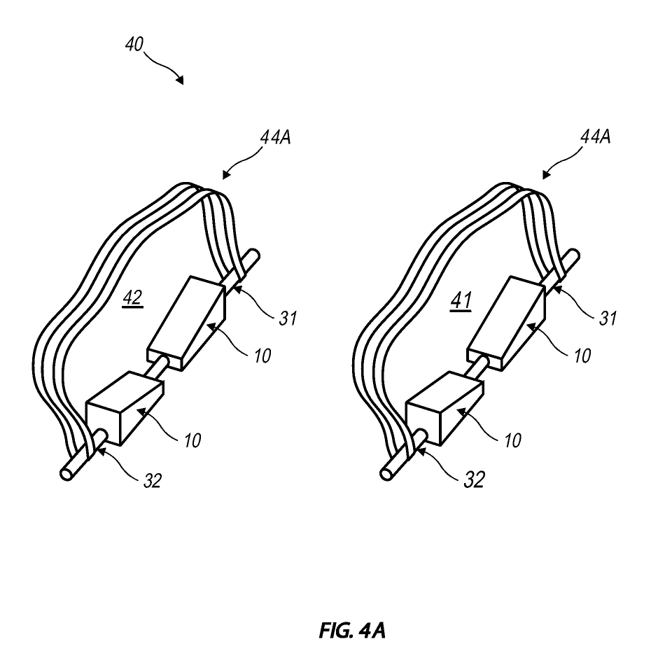

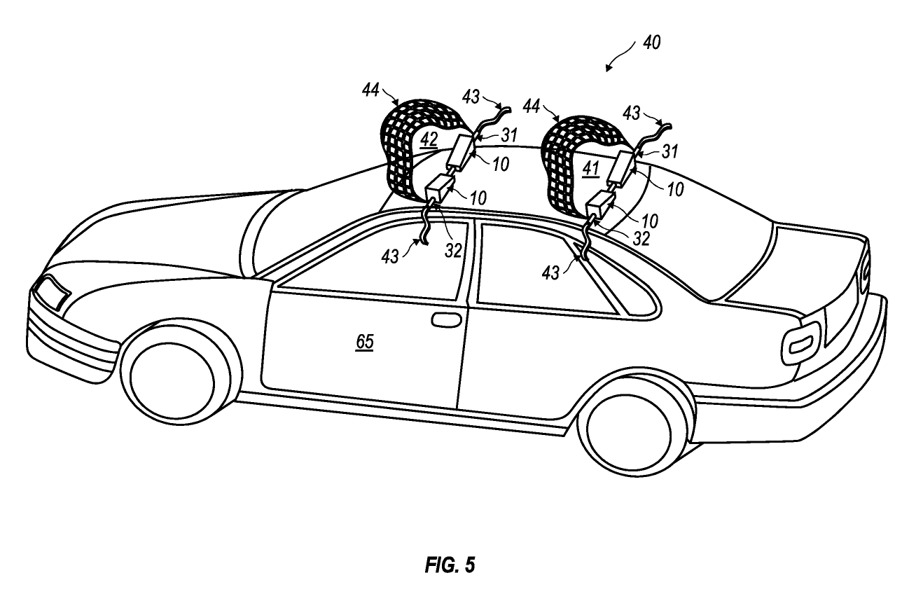

FIG. 4 is an illustration of two saddles 41 and 42 forming kayak carrier 40 in accordance with the present disclosure. In one embodiment, each saddle 41, 42 can include two supports 10, which can be used to support a kayak. Saddle 41 can be used for the rear of a vehicle and another saddle 42 can be used for the front. However, in one embodiment, there may be only one elongate saddle for the entire kayak. The elongate saddle could extend the entire length of the vehicle roof or any suitable portion of the roof length to carry a larger portion of the kayak. Kayak carrier 40 also includes fasteners, such as straps 43, for securing kayak carrier 40 to a vehicle. Strap 43 can extend through channels 32, thereby allowing kayak carrier 40 to be secured to a vehicle roof by running strap 43 through vehicle openings when the door is ajar or through the vehicle's windows and around the roof. The straps can be tied together or secured by a latching mechanism, such as a ratchet or hooks. As an example, a user can feed straps 43 through open doors of the vehicle and can tie the straps 43 together inside the vehicle or outside the vehicle. As another example, if the straps 43 include a latching mechanism, the user may feed the straps 43 as discussed in the previous case and can secure the straps 43 together either inside or outside the vehicle. In one arrangement, the straps 43 can be thin enough to allow a user to close the doors or other opening of the vehicle that the straps 43 have been fed through once the straps 43 have been tied or secured to one another.

In one arrangement, a kayak can be secured to kayak carrier 40 via netting 44. Netting 44 can be in two pieces (one piece for each saddle 41, 42), and can be secured to saddles 41 and 42 through channels 32; however, in one alternative embodiment, netting 44 can be secured to carrier 40 by wrapping it around guides 31. Mechanisms other than netting 44 can be used to secure the kayak to the kayak carrier 44. For example, one or more straps 44A can be secured to guides 31 as shown in FIG. 4A, or one or more of the supports 10, and can be wrapped over or even around the kayak to secure the kayak to the vehicle.

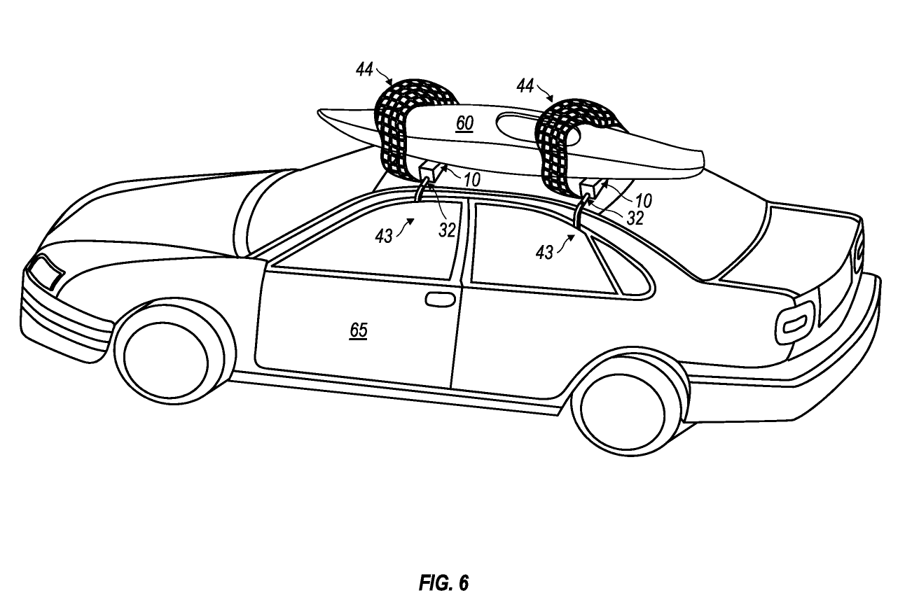

FIG. 5 is an illustration of kayak carrier 40 in an installed configuration and resting on, and in contact with, a vehicle roof in a configuration for supporting a kayak. Here, the supports 10 can be in direct contact with the roof or other suitable surface of the vehicle. This configuration, along with the ability of the straps 43 to be secured either inside or outside the vehicle, can eliminate the need for a roof rack if desired. As previously noted, kayak carrier 40 can further include netting 44 for securing a kayak to the vehicle. Netting 44 can be secured around the guide 31 of saddles 41 and 42 as illustrated. In other embodiments, netting 44 can be secured by feeding a portion of the netting through channels 32. In still further embodiments, netting 44 can be secured through the vehicle similar to straps 43.

FIG. 6 is an illustration of kayak carrier 40 in an installed configuration with a kayak 60 secured to a vehicle 65. As can be seen, the netting 44 can wrap around the kayak 60, thereby securing the kayak 60 to the saddles 41, 42 and the vehicle 65. In this case, although without limitation, the saddle 41 can be positioned near the rear of the vehicle 65, while the saddle 42 can be positioned near the front of the vehicle 65.

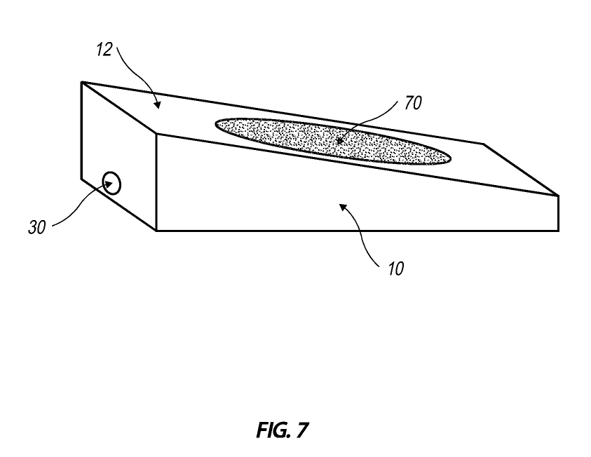

FIG. 7 illustrates another embodiment of the present disclosure in which the supports 10 can include either relatively low or high-friction surfaces 70, with respect to each other. Specifically, saddle 41, which can be positioned on the rear of the vehicle 65 (see FIG. 6), comprises one or more supports 10 having a relatively low-friction sliding surface 70, thereby allowing kayak to slide over saddle 41 during installation of a kayak on the vehicle. More specifically, a user will typically slide the kayak over the rear saddle 41 and gently drop the kayak onto the front saddle 42. The relatively low-friction surfaces 70 of the supports 10 of the rear saddle 41 facilitate the sliding of the kayak. In contrast, saddle 42, on the front of the vehicle, comprises one or more supports 10 having a high-friction gripping surface 70, thereby retaining the kayak on saddle 42 on the front of the vehicle. As such, the kayak-engaging surfaces 70 of the supports 10 of the saddle 41 at the rear of the vehicle can have a lower friction coefficient than the friction coefficient of the kayak-engaging surfaces 70 of the supports 10 of the saddle 42 at the front of the vehicle. The relatively high and low friction surfaces 70 can be placed on the supports 10 via, for example, an adhesive.

Supports 10 can also comprise a high-friction surface (not illustrated), such as rubber, on their bases. This surface will prevent saddles 41 and 42 from sliding on the vehicle roof.

While described generally herein, the cradle can be used for many purposes that would benefit from the features described herein, such as carrying items other than a kayak. In the drawings and specification, there have been disclosed embodiments and examples, although specific terms are employed, they are used in a generic and descriptive sense only and not for the purpose of limitation, the scope of the disclosure being set forth in the following claims.

We claim:

1. A kayak carrier comprising:
first and second supports, each comprising a top surface having a slope relative to corresponding bottom surfaces, wherein the slopes of the first and second supports form a generally concave receiving surface in an installed configuration for a front of a vehicle; and
third and fourth supports, each comprising a top surface having a slope relative to corresponding bottom surfaces, wherein the slopes of the third and fourth supports form a generally-concave receiving surface in an installed configuration for a rear of a vehicle, and wherein the first and second supports are configured to be arranged to support a first end of a kayak, and wherein the third and fourth supports are configured to be arranged to support a second end of the kayak.

2. The kayak carrier of claim 1, wherein the supports rest on the vehicle in an installed configuration.

3. The kayak carrier of claim 1, wherein each of the supports further comprises a through-hole extending length-wise from one end to another.

4. The kayak carrier of claim 2 further comprising a first guide configured to slidably engage the first and second supports; and
a second guide configured to slidably engage the third and fourth supports.

5. The kayak carrier of claim 2 further comprising a first strap configured to secure the first and second supports to the vehicle; and
a second strap configured to secure the third and fourth supports to the vehicle.

6. The kayak carrier of claim 1, wherein the first and second supports further comprise kayak-engaging surfaces that resist movement of a kayak in an installed configuration.

7. The kayak carrier of claim 6, wherein the third and fourth supports further comprise kayak-engaging surfaces that facilitate a sliding motion of a kayak when the kayak is being placed in the installed configuration.

8. The kayak carrier of claim 7, wherein the kayak engaging surfaces of the third and fourth supports have a lower friction coefficient than the kayak-engaging surfaces of the first and second supports.

9. The kayak carrier of claim 1 further comprising netting configured for securing a kayak to the kayak carrier.

10. The kayak carrier of claim 2, wherein the through-holes are configured for being coupled to a multi-purpose vehicle roof rack.

11. The kayak carrier of claim 1, wherein the supports comprise a generally trapezoidal block-like shape.

12. The kayak carrier of claim 1, wherein the supports comprise solid foam.

13. A kayak carrier comprising:
first, second, third and fourth supports, each comprising at least one through-hole; and
first and second guides;
wherein the through-holes of the first and second supports are configured to slidably accept the first guide to form a first saddle;
wherein the through-holes of the third and fourth supports are configured to slidably accept the second guide to form a second saddle, wherein the first and second saddles are configured to receive a kayak.

14. The kayak carrier of claim 13, wherein the first and second guides each comprise two ends and a channel with openings on each end of each of the guides.

15. The kayak carrier of claim 14 further comprising first and second fasteners corresponding to the channels of the first and second guides respectively, wherein the fasteners are configured to couple the first and second guides to a vehicle.

16. The kayak carrier of claim 15, wherein the first and second fasteners comprise straps.

17. The kayak carrier of claim 13, wherein the first and second supports further comprise kayak-engaging surfaces that resist movement of a kayak in an installed configuration.

18. The kayak carrier of claim 17, wherein the third and fourth supports further comprise kayak-engaging surfaces that facilitate a sliding motion of a kayak when the kayak is being placed in the installed configuration.

19. The kayak carrier of claim 18, wherein the kayak engaging surfaces of the third and fourth supports have a lower friction coefficient than the kayak-engaging surfaces of the first and second supports.

20. The kayak carrier of claim 13, wherein the first and second guides constitute portions of a multi-purpose vehicle roof rack.

21. A kayak carrier comprising:
a first saddle;
a second saddle;
wherein the first and second saddles each comprise two blocks with one or more longitudinal through-holes;
the first and second saddles further comprise at least one guide, comprising two ends, extending through at least one of the longitudinal through-holes, wherein each guide has an opening extending from one end of the guide to the other end; and
one or more straps to fit through the opening of each of the at least one guide and configured to attach the kayak carrier to a vehicle.
